(19) United States
(12) Patent Application Publication
(10) Pub. No.: US 2014/0110398 A1
(43) Pub. Date: Apr. 24, 2014

(54) HEATER APPARATUS

(71) Applicant: Tokyo Electron Limited, Tokyo (JP)

(72) Inventor: Makoto Kobayashi, Iwate (JP)

(73) Assignee: Tokyo Electron Limited, Tokyo (JP)

(21) Appl. No.: 14/050,843

(22) Filed: Oct. 10, 2013

(30) Foreign Application Priority Data
Oct. 24, 2012 (JP) 2012-234684

(51) Int. Cl. H05B 3/46

(52) U.S. Cl. CPC H05B 3/46
USPC 219/534

(57) ABSTRACT

Provided is a heater apparatus capable of preventing the movement of a heater element. The heater apparatus includes a heat insulating material, a cylindrical support disposed in the vicinity of the heat insulating material, a heater element formed by being spirally wound around the outer circumference of the support a plurality of times, and a movement preventing member configured to prevent the movement of the heater element in the axial direction of the support.

### CROSS-REFERENCE TO RELATED APPLICATIONS

This application is based on and claims priority from Japanese Patent Application No. 2012-234684 filed on Oct. 24, 2012 with the Japan Patent Office and the disclosure of which is incorporated herein in its entirety by reference.

### TECHNICAL FIELD

The present disclosure relates to a heater apparatus.

### BACKGROUND

In a semiconductor manufacturing apparatus, surface processings such as, for example, a film forming processing and an etching processing are performed on a semiconductor wafer which is an object to be processed. In such a case, in order to maintain a temperature at which various processings are performed, a heater apparatus such as, for example, a panel heater may be provided in the vicinity of a mounting table where the object to be processed is mounted.

The panel heater includes a heat insulating material which has, for example, a plate shape, a cylindrical support disposed in the vicinity of the heat insulating material, and a resistance heat-generating element (a heater element) formed by being spirally wound around the outer circumference of the support with a predetermined gap (clearance). See, for example, Japanese Patent Laid-Open Publication No. H9-92657.

The panel heater disclosed in Japanese Patent Laid-Open Publication No. H9-92657 is configured to dispose the heater element efficiently at a predetermined space. Thus, the panel heater enables rapid increase and decrease of temperature and the panel heater is used for various purposes other than for a semiconductor manufacturing apparatus.

### SUMMARY

A heater apparatus according to the present disclosure includes: a heat insulating material; a cylindrical support disposed in the vicinity of the heat insulating material; a heater element formed by being spirally wound around the outer circumference of the support a plurality of times; and a movement preventing member configured to prevent the movement of the heater element in an axial direction of the support.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A to 1C are schematic configurational views illustrating an example of a heater apparatus according to the present disclosure.

FIG. 2 is a schematic view for describing the movement of the heater element.

FIGS. 3A and 3B are schematic views for describing problems of a region where the winding density of the heater element is low.

FIG. 4 is a schematic configurational view illustrating a heater apparatus according to a first exemplary embodiment.

FIGS. 5A to 5D are schematic configurational views illustrating a heater apparatus according to a second exemplary embodiment.

FIGS. 6A and 6B are schematic configurational views illustrating a heater apparatus according to a third exemplary embodiment.

FIGS. 7A to 7C are schematic configurational views illustrating a heater apparatus according to a fourth exemplary embodiment.

FIG. 8 is a photographic of a heater apparatus after a temperature increase/decrease test.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made without departing from the spirit or scope of the subject matter presented here.

In the panel heater disclosed in Japanese Patent Laid-Open Publication No. H9-92657, the heater element moves irregularly along the axial direction of the support due to repetition of thermal expansion and thermal shrinkage when the temperature is increased and decreased. Consequently, a region where the heater element is sparse and a region where the heater element is dense exist along the axial direction of the support.

In the region where the heater element is sparse, a clearance is eliminated since the winding diameter of the heater element becomes small. When the heater element shrinks in this state, the support may be compressed and damaged. Meanwhile, in the region where the heater element is dense, deterioration of the heater element is rapidly deteriorated since the temperature is increased over a predetermined value during heat generation due to the closely wound heat element.

The present disclosure has been made in an effort to solve the problems as described above and provides a hater apparatus capable of suppressing the movement of a heater element.

A heater apparatus according to an aspect of the present disclosure includes: a heat insulating material; a cylindrical support disposed in the vicinity of the heat insulating material; a heater element formed by being spirally wound around the outer circumference of the support a plurality of times; and a movement preventing member configured to prevent the movement of the heater element in the axial direction of the support.

In the above-described heater apparatus, the movement preventing member is a U-shaped pin type member and two ends of the U-shaped pin type member are fixed to the heat insulating material. The support is disposed within a region which is surrounded by the pin member and the heat insulating material.

In the above-described heater apparatus, the movement preventing member is contacted and fixed to at least a portion of the outer circumference of the support and formed between windings of the heater element which are adjacent to each other in the axial direction of the support.

In the above-described heater apparatus, the movement preventing member is formed over the entire circumference of the support and the outer circumference has a circular shape when viewed from the axial direction.

In the above-described heater apparatus, the movement preventing member is formed over the entire circumference of the support and the outer circumference has a rectangular shape when viewed in the axial direction.

In the above-described heater apparatus, the movement preventing member includes a pin type member extending to the outside of the support in the radial direction of the support.

In the above-described heater apparatus, the movement preventing member includes a plate-shaped member which one end is fixed to the support and the other end is fixed to the heat insulating material.

In the above-described heater apparatus, a plurality of the movement preventing members are provided and the plurality movement preventing members are disposed every predetermined number of windings of the heater element.

In the above-described heater apparatus, a plurality of the movement preventing members are provided a plurality of times and the plurality of movement preventing members are disposed every predetermined length of the support.

In the above-described heater apparatus, the support and the heater element are designed to be spaced apart from each other in the radial direction by 0.5 mm or more.

A heater apparatus capable of preventing the movement of a heater element may be provided.

Hereinafter, exemplary embodiments of the present disclosure will be described with reference to the accompanying drawings.

(Configuration of Heater Apparatus)

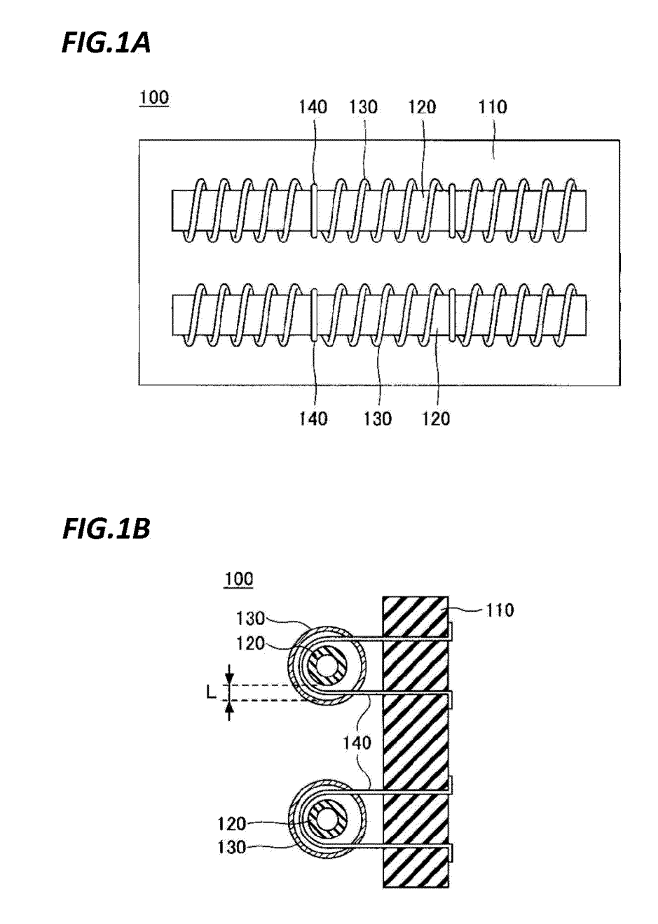

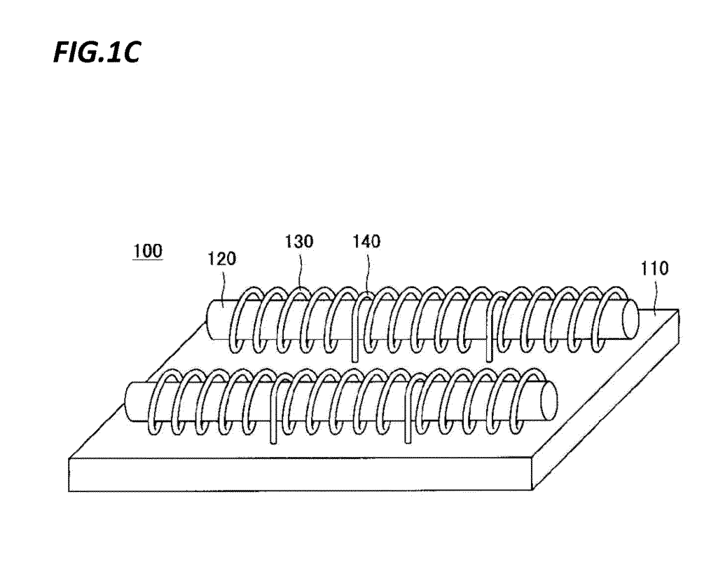

First, a basic configuration of a heater apparatus according to the present disclosure will be described. FIGS. 1A to 1C are schematic configurational views illustrating an example of the heater apparatus according to the present disclosure. Specifically, FIG. 1A illustrates a schematic front view of the heater apparatus, FIG. 1B illustrates a schematic side view of the heater apparatus, and FIG. 1C illustrates a schematic perspective view of the heater apparatus.

The heater apparatus 100 of the present disclosure includes a heat insulating material 110 which has, for example, a plate shape, a cylindrical support 120 disposed in the vicinity of the heat insulating material 110, and a resistance heat-generating element 130 (a heater element) formed by being spirally wound around the outer circumference of the support 120 a plurality of times. The heater apparatus with the above-described configuration is generally used as, for example, a panel heater. Also, in FIGS. 1A to 1C, two supports 120 and two heater elements 130 are illustrated.

Also, the heater apparatus 100 of the present disclosure includes a movement preventing member 140 configured to limit the movement of the heater element 130 in the axial direction of the support 120. The movement preventing member 140 is disposed at a predetermined location between windings of the heater element 130 which are adjacent to each other in the axial direction of the support 120.

Depending on, for example, the length in the axial direction of the support 120 and the winding number of the heater element 130, one or more movement preventing members 140 are disposed. Also, in FIGS. 1A to 1C, the movement preventing member 140 of the first exemplary embodiment, which will be described later, is illustrated. However, the present disclosure is not limited thereto and various configurational examples of the movement preventing member 140 will be described later.

In this specification, the terms, axial direction and radial direction refer to the axial direction and the radial direction of the cylindrical support 120, respectively, unless clearly defined otherwise.

The support 120 is a core body configured to support the spirally wound heater element 130 and it is formed in a cylindrical shape. As illustrated in FIG. 1B, the support 120 is generally formed in a hollow structure. However, the present disclosure is not limited thereto.

The diameter of the support 120 is not specifically limited but in the range of, for example, φ9 mm to φ50 mm.

In FIGS. 1A to 1C, a configuration in which a heater apparatus is provided with two supports 120 is illustrated. However, the present disclosure is not limited thereto and may have a configuration in which one support 120 or three or more supports 120 may be disposed on one heater apparatus. When two or more supports 120 are provided, the respective supports are generally arranged at predetermined intervals in parallel to each other. With such a configuration, the heater apparatus may heat a broad range uniformly.

As for the material of the support 120, a heat-resistant insulating material is generally used and ceramic materials such as, for example, alumina, silicon carbide, and silicon oxide, are preferably used.

The heater element 130 is a tubular resistance heat-generating element having a cross-sectional diameter in the range of, for example, 1 mm to 10 mm and is formed by being spirally wound around the outer circumference of the support 120 a plurality of times. The winding diameter of the heater element 130 depends on, for example, the diameter of the support 120 but is, for example, φ5 mm to φ60 mm. Also, a gap may be formed between the heater element 130 and the support 120. A radial distance between the heater element 130 and the support 120 (referred to as a clearance L) is generally designed to be 0 mm to 1 mm, preferably 0.5 mm to 1 mm in a design at the time of production.

The material of the heater element 130 is not specifically limited. The heater element 130 may be formed of a metal based material such as, for example, an iron-chrome-aluminum based (Fe—Cr—Al based) alloy, a nickel-chrome based (Ni—Cr based) alloy, molybdenum, tungsten, tantalum, and platinum, or a nonmetal based material. Also, the ends of the heater element 130 are connected to electrodes (not illustrated) so that heat is generated in the heater element by resistance heating.

(Problems of Conventional Heater Apparatus)

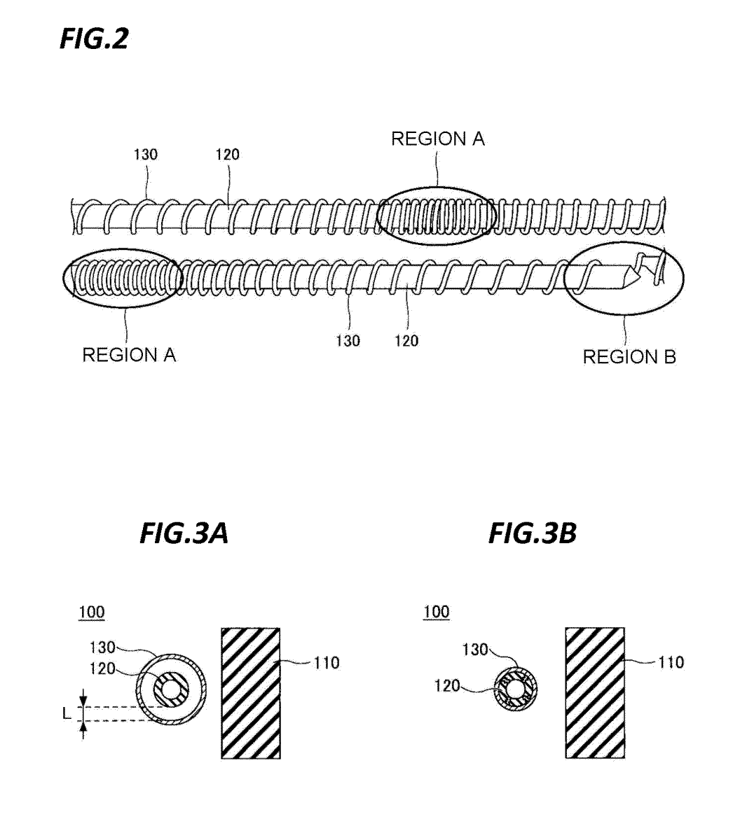

FIG. 2 is a schematic view for describing the movement of a heater element. More specifically, FIG. 2 illustrates an arrangement example of the heater element 130 of the heater apparatus 100 after the increase and decrease of temperature are repeated.

As illustrated in FIG. 2, the heater apparatus 100 after the repeated increase and decrease of temperature has a region where the heater element 130 is dense and a region where the heater element 130 is sparse. The region where the heater element 130 is dense refers to, more specifically, a region where the winding density of the heater element 130 is higher than, a predetermined value which is, for example, the winding density of the initial arrangement. The region where the heater element 130 is sparse refers to a region where the winding density of the heater element 130 is lower than, for example, the predetermined value which is the winding density of the initial arrangement.

In the region A, since the heater element 130 becomes dense as compared to the initial arrangement, the temperature is raised over a preset temperature when heated and as a result, the heater element 130 may deteriorate easily.

Meanwhile, in the region B, the heater element 130 becomes sparse as compared to the initial arrangement. FIGS. 3A and 3B are schematic views for describing the problems of the region B where the winding density of the heater element 130 is low. Specifically, FIG. 3A is a schematic view illustrating the heater element 130 and the support 120 when viewed in the axial direction of the support 120 before the increase and decrease of temperature and FIG. 3B is a schematic view illustrating the heater element 130 and the support 120 when viewed in the axial direction of the support 120 after the repeated increase and decrease of temperature. In FIGS. 3A and 3B, the movement preventing members 140 and the heat insulating material 110 are omitted for the convenience of description.

As illustrated in FIG. 3A, the above-described clearance L is sufficiently secured between the heater element 130 and the support 12 before the increase and decrease temperature. However, as illustrated in FIG. 3B, the clearance L disappears from the heater element 130 in the region B where the winding density is low after the temperature is increased or decreased repeatedly since the winding diameter is reduced. When the heater element 130 is thermally further shrunk in this state, the support 120 is compressed by the heater element 130 and may be destroyed.

In order to solve the problems as described above, the movement preventing members 140 prevent the movement of the heater element 130 in the axial direction of the support 120. Various exemplary embodiments thereof will be described below.

### First Exemplary Embodiment

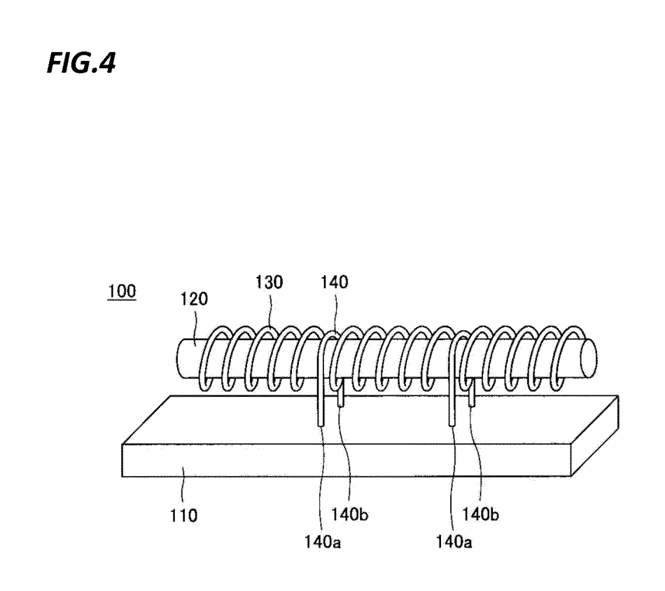

FIG. 4 is a schematic configurational view illustrating the heater apparatus 100 according to the first exemplary embodiment.

As illustrated in FIG. 4, in the first exemplary embodiment, each of the movement preventing members 140 is, for example, a pin type member which is formed substantially in a U-shape and two ends 140a, 140b of each movement preventing member 140 are fixed to the heat insulating material 110.

In the first exemplary embodiment, the support 120 is disposed within a region which is surrounded by the movement preventing members 140 and the heat insulating material 110.

The support 120 and the movement preventing members 140 may be contacted and fixed to or separated from each other. When the support 120 is separated from the movement preventing members 140, the distance between the support 120 and the movement preventing member 140 is designed, depending on, for example, the diameter of the heater element 130 and the above-described clearance L, to be capable of preventing the movement of the heater element 130 in the axial direction of the support 120.

One or more movement preventing members 140 of the first exemplary embodiment are disposed along the axial direction of the support 120. When two or more movement preventing members 140 are disposed, it is desirable that the two or more movement preventing members 140 are arranged at a predetermined pitch. For example, the movement preventing members 140 may be arranged either every predetermined length in the axial direction of the support 120 or every predetermined number of windings of the heater element 130, for example, every five to seven turns.

The cross-sectional shape of the movement preventing member 140 of the first exemplary embodiment is not particularly limited and may be, for example, a circular shape, an elliptical shape, and a rectangular shape. Also, the movement preventing members 140 may be hollow.

The fixation of the movement preventing members 140 of the first exemplary embodiment to the heat insulating material 110 is not particularly limited. For example, as illustrated in FIG. 1B, the movement preventing members 140 may penetrate the heat insulating material 110 so that the movement preventing members 140 may be fixed by a stopper (not illustrated) on the surface of the heat insulating material 110 at the side where the movement preventing members 140 do not exist.

As for the movement preventing member 140 of the first exemplary embodiment, like the above-described support 120, a heat-resistant insulating material such as, for example, alumina may be used. However, a material which is the same as that used for the heater element 130 may be used.

### Second Exemplary Embodiment

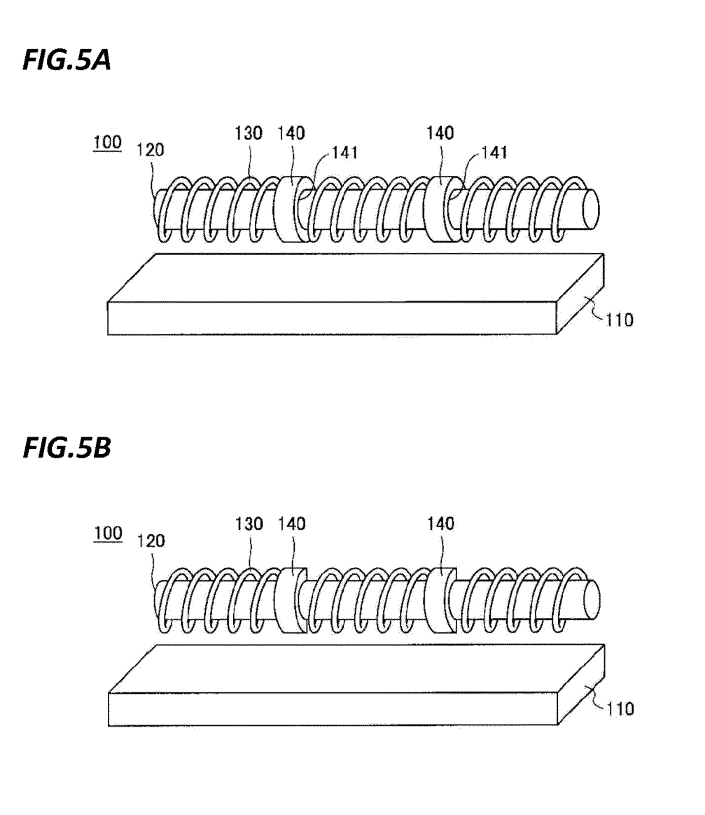

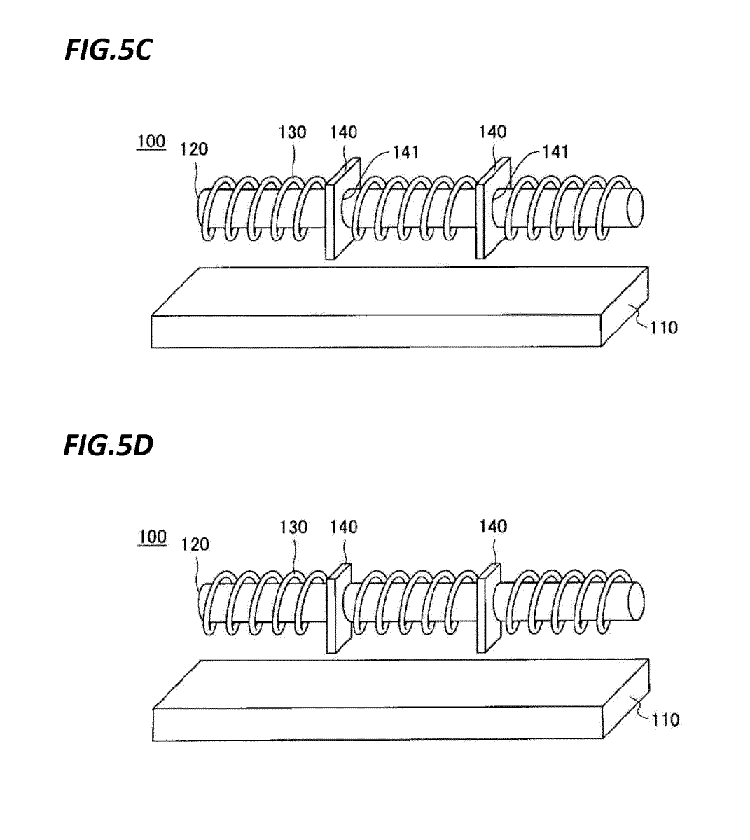

FIGS. 5A to 5D are schematic configurational views of an example of the heater apparatus 100 according to the second exemplary embodiment.

In the second exemplary embodiment illustrated in FIGS. 5A to 5D, the movement preventing members 140 are configured to be contacted and fixed to at least a portion of the outer circumference of the support 120. Also, a portion of each of the movement preventing members 140 of the second exemplary embodiment is formed between windings of the heater element 130 which are adjacent to each other in the axial direction of the support 120 and the movement of the heater element 130 in the axial direction may be prevented by the movement preventing members 140.

In the example of FIG. 5A, the movement preventing members 140 are formed over the entire outer circumference of the support 120 and the shape of the outer circumference of each of the movement preventing members 140 when viewed in the axial direction of the support 120 is a circular shape. More specifically, each of the movement preventing members 140 is a cylindrical member having a cutout portion 141 which is formed by cutting the central portion in a circular shape and the outer circumference of the cut-out portion 11 is correspondingly fixed to the outer circumference of the support 120.

Also, the movement preventing members 140 of FIG. 5B correspond to the movement preventing members of FIG. 5A, except that the movement preventing members 140 of FIG. 5B are formed along only a portion of the support 120 in the circumferential direction. As illustrated in FIG. 5B, each of the movement preventing members 140 may be formed on a portion of the outer circumference of the support 120. For example, when viewed in the axial direction of the support 120, a region where the movement preventing members 140 exist may be an half of the circumference of the support 120.

In the example of FIG. 5C, each of the movement preventing members 140 is formed over the entire outer circumference of the support as in the example of FIG. 5A and the outer circumference shape when viewed in the axial direction of the support 120 is a rectangular shape. Specifically, each of the movement preventing members 140 is a plate-shaped member having the cut-out portion 141 formed by cutting a central portion in a circular shape and the outer circumference of the cut-out portion 141 is fixedly engaged with the outer circumference of the heater element 130.

The movement preventing members 140 of FIG. 5D correspond to the movement preventing members of FIG. 5C, except that the movement preventing members 140 of FIG. 5D are formed along only a portion of the support 120 in the circumferential direction. As illustrated in the example of FIG. 5D, the movement preventing members 140 may be formed on a portion of the outer circumference of the support 120. For example, as in the example of FIG. 5D, the movement preventing members 140 may be formed along an half of the circumference of the support 120.

The size of the movement preventing members 140 of the second exemplary embodiment are designed, depending on, for example, the diameter or the heater element 130 and the above-described clearance L, to be capable of preventing the movement of the heater element 130 in the axial direction of the support 120.

As for the movement preventing members 140 of the second exemplary embodiment, like the above-described support 120, a heat-resistant insulating material such as, for example, alumina, may be used. The movement preventing members 140 of the second exemplary embodiment may be integrally formed with the support 120. Alternatively, the support 120 and the movement preventing members 140 may be formed separately in advance and joined each other to fix the movement preventing members 140 to the support 120.

One or more movement preventing members 140 of the second exemplary embodiment are disposed along the axial direction of the support 120. When two or more movement preventing members 140 are disposed, it is desirable that the two or more movement preventing members 140 are arranged at a predetermined pitch. For example, the movement preventing members 140 may be arranged every predetermined length in the axial direction of the support 120 or every predetermined number of windings of the heater element 130.

### Third Exemplary Embodiment

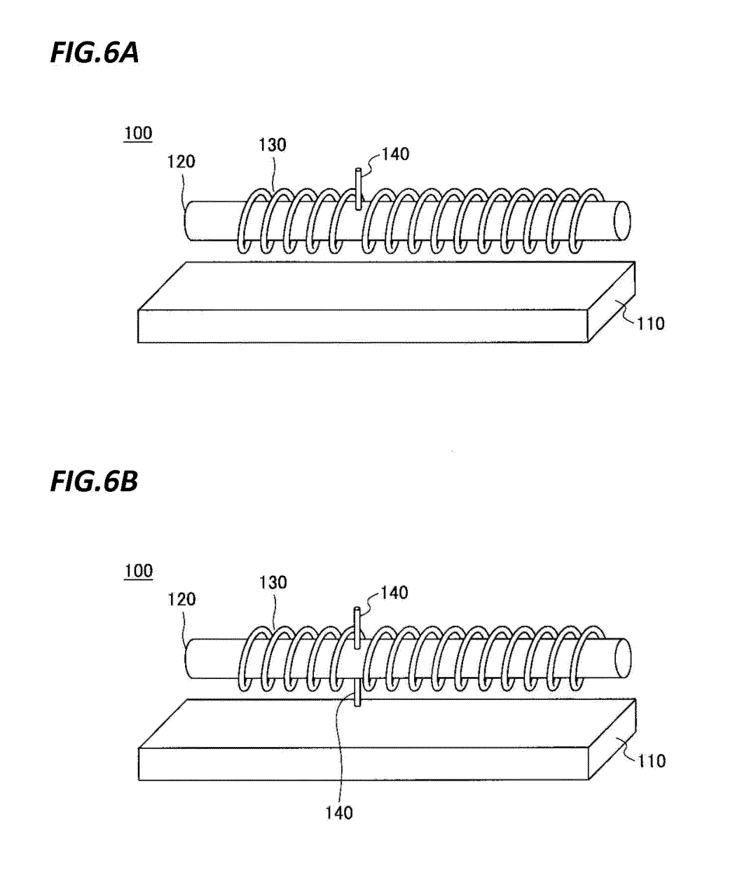

FIGS. 6A and 6B are schematic views illustrating an example of the configuration of the heater apparatus 100 according to the third exemplary embodiment.

As illustrate in FIG. 6A, the movement preventing members 140 of the third exemplary embodiment are pin type members extending from the support 120 to the outside in the radial direction of the support 120.

Also, as illustrated in FIG. 6B, two or more movement preventing members 140 of the third exemplary embodiment may be formed along the circumferential direction of the support 120. When two movement preventing members 140 are formed along the circumferential direction of the support 120, it is desirable that the two movement preventing members 140 are formed on the opposite sides when viewed in the axial direction of the support 120. In this case, the two movement preventing members 140 may be integrally formed. Through holes which extend from one side surface to the other side surface is formed and the movement preventing members 140 extend to the outside in the radial direction of the support 120 via the through holes, respectively.

The cross-sectional shape of each of the movement preventing members 140 of the third exemplary embodiment is not limited to a particular shape and may be, for example, a circular shape, an elliptical shape, and a rectangular shape. Also, the movement preventing members 140 may be hollow.

The length of the movement preventing members 140 of the third exemplary embodiment is designed, depending on, for example, the diameter of the heater element 130 and the above-described clearance L, to be capable of preventing the movement of the heater element 130 in the axial direction of the support 120.

As for the movement preventing members 140 of the third exemplary embodiment, like the above-described support 120, a heat-resistant insulating material such as, for example, alumina, may be used. However, a material which is the same as the material used for the heater element 130 may be used.

One or more movement preventing members 140 of the third exemplary embodiment are disposed along the axial direction of the support 120. When two or more of movement preventing members 140 are disposed, it is desirable that the two or more movement preventing members 140 are arranged at a predetermined pitch. For example, the movement preventing members 140 may be arranged either every predetermined length in the axial direction of the support 120 or every predetermined number of windings of the heater element 130.

### Fourth Exemplary Embodiment

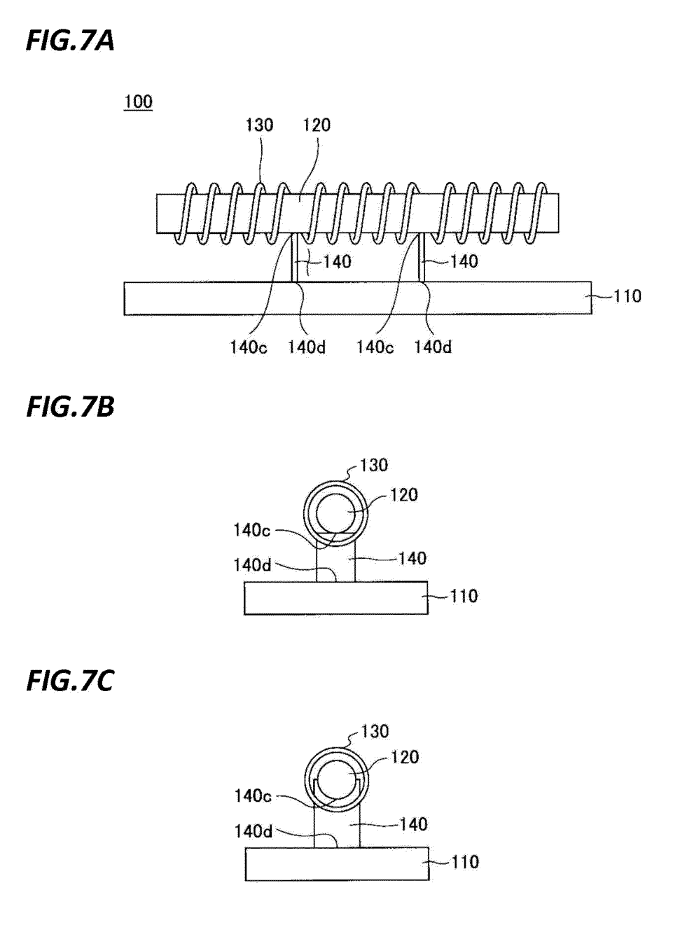

FIG. 7A is a schematic configurational view illustrating the heater apparatus 100 according to the fourth exemplary embodiment and FIG. 7B is a schematic view illustrating FIG. 7A when viewed in the axial direction of the support 120. FIG. 7C is a schematic view illustrating another example of the heater apparatus 100 according to the fourth exemplary embodiment when viewed in the axial direction of the support.

As illustrated in FIG. 7A, each of the movement preventing members 140 of the fourth exemplary embodiment may be a plate-shaped member that has a first end portion 140c fixed to the support 120 and a second end portion 140d fixed to the heat insulating material 110.

In each of the movement preventing members 140 of the fourth exemplary embodiment, the shape of the first end portion 140c is not limited as long as the first end portion 140c may be fixed to the support 120. For example, as illustrated in FIG. 7B, the movement preventing members 140 may be fixed to be in contact with the outer circumference of the support 120. In addition, as illustrated in FIG. 7C, the first end portion 140c may be formed to be fixed to at least a portion of the outer circumference of the support 120.

In each of the movement preventing members 140 of the fourth exemplary embodiment, the second end portion 140d is fixed to the heat insulating material 110. For example, a portion of each of the movement preventing members 140 may be embedded in the heat insulating material 110 and fixed. Alternatively, the movement preventing members 140 may be fixed in a different form.

As for the movement preventing members 140 of the fourth exemplary embodiment, like the above-described support 120, a heat-resistant insulating material such as, for example, alumina, may be used.

One or more movement preventing member(s) 140 of the fourth exemplary embodiment are disposed along the axial direction of the support 120. When two or more movement preventing members 140 are disposed, it is desirable that the two or more movement preventing members 140 are arranged at a predetermined pitch. For example, the movement preventing members 140 may be arranged either every predetermined length in the axial direction of the support 120 or every predetermined number of windings of the heater element 130.

### Example

An Example from which the effects of the heater apparatus 100 having the movement preventing members 140 have been confirmed will be described.

First, a support 120 of φ10 mm was disposed in the vicinity of a heat insulating material 110 and the heater element 130 was wound around the outer circumference of the support 120 a plurality of times. As for the heater element 130, a Fe—Cr—Al based heater element of φ3 mm was used. Also, the winding condition of the heater element 130 was that the inner winding diameter of the heater element was set to φ14 mm (i.e., the clearance L was 2 mm). Also, the movement preventing members 140 of the first exemplary embodiment illustrated in FIG. 4 were installed every five to seven turns of the heater element, thereby fabricating a heater apparatus 100 of Example.

As for a heater apparatus of Comparative Example, a heater apparatus which is the same as the heater apparatus of Example 1 except that a support of φ13 mm was disposed and the clearance L was set to 0.5 mm was fabricated.

Using the heater apparatuses of Example and Comparative Example, a temperature increase/decrease test in which 1,500 cycles of the increase and decrease of temperature from 300° C. to 1050° C. are repeated was performed.

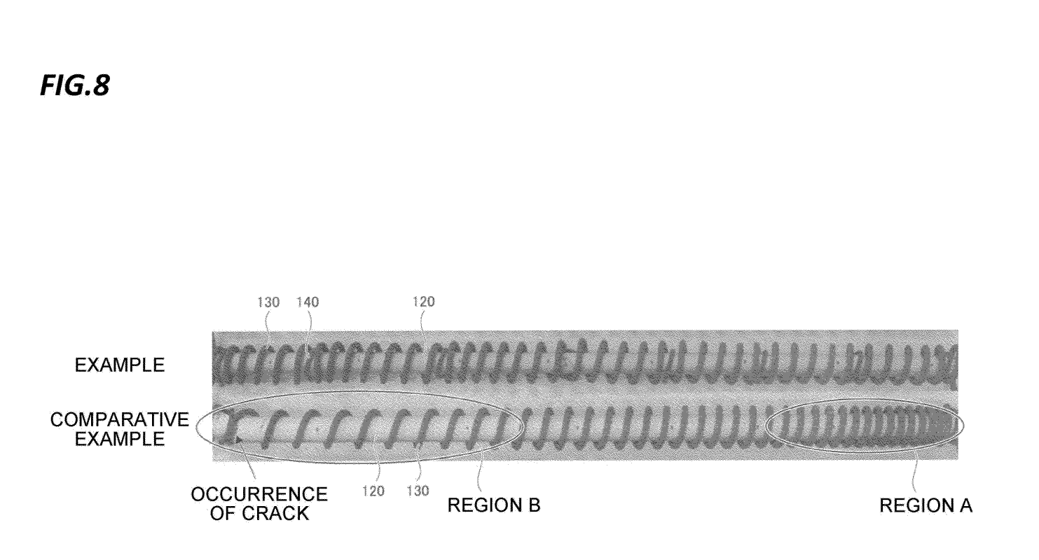

FIG. 8 is a photographic of the heater apparatus of Example after a temperature increase/decrease test. It may be seen that, in the heater apparatus of Example, the heater element exists at the substantially same pitch along the axial direction of the support even after the temperature increase/decrease test. In the heater apparatus of Comparative Example, however, the heater element moves along the axial direction of the support and a dense region A where the windings of the heater element are dense and a sparse region B where the windings of the heater element are sparse have been formed. Also, in the sparse region B where the windings of the heater element are sparse, a cracked portion of the support exists.

From Example and Comparative Example, it has been confirmed that the movement of the heater element having the movement preventing members according to the present disclosure may be prevented even when the increase and decrease of temperature have been repeated.

As described above, a heater apparatus of the present disclosure includes a heat insulating material which has a plate shape, a cylindrical support disposed in the vicinity of the heat insulating material, a heater element formed by being spirally wound around the outer circumference of the support a plurality of times, and a movement preventing member configured to prevent the movement of the heater element in the axial direction of the support. Thus, the movement of the heater element in the axial direction of the support may be prevented even when the increase and decrease of temperature have been repeated.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A heater apparatus comprising:
a heat insulating material;
a cylindrical support disposed in the vicinity of the heat insulating material;
a heater element formed by being spirally wound around an outer circumference of the support a plurality of times; and
a movement preventing member configured to prevent the movement of the heater element in an axial direction of the support.

2. The heater apparatus of claim 1, wherein the movement preventing member includes a U-shaped pin type member, two ends of the U-shaped pin type member are fixed to the heat insulating material, and the support is disposed within a region which is surrounded by the pin member and the heat insulating material.

3. The heater apparatus of claim 1, wherein the movement preventing member is contacted and fixed to at least a portion of the outer circumference of the support, and the movement preventing member is formed between windings of the heater element which are adjacent to each other in the axial direction of the support.

4. The heater apparatus of claim 3, wherein the movement preventing member is formed over the entire circumference of the support, and the outer circumference has a circular shape when viewed in the axial direction.

5. The heater apparatus of claim 3, wherein the movement preventing member is formed over the entire circumference of the support, and the outer circumference has a rectangular shape when viewed in the axial direction.

6. The heater apparatus of claim 1, wherein the movement preventing member includes a pin type member extending to the outside of the support in a radial direction.

7. The heater apparatus of claim 1, wherein the movement preventing member includes a plate-shaped member of which one end is fixed to the support and the other end is fixed to the heat insulating material.

8. The heater apparatus of claim 1, wherein a plurality of the movement preventing members are provided, and the plurality of movement preventing members are disposed every predetermined numbers of windings of the heater element.

9. The heater apparatus of claim 1, wherein a plurality of the movement preventing members are provided, and the plurality of movement preventing members are disposed every predetermined length of the support.

10. The heater apparatus of claim 1, wherein the support and the heater element are designed to be spaced apart from each other in a radial direction by 0.5 mm or more.
